(19) United States
(12) Patent Application Publication
(10) Pub. No.: US 2016/0239130 A1
(43) Pub. Date: Aug. 18, 2016

(54) TOUCH PANEL AND TOUCH DISPLAY DEVICE USING THE SAME

(71) Applicant: Innolux Corporation, Chu-Nan (TW)

(72) Inventors: Yang-Chen CHEN, Chu-Nan (TW); Chia-Hsiung CHANG, Chu-Nan (TW); Hsia-Ching CHU, Chu-Nan (TW)

(73) Assignee: INNOLUX CORPORATION, Chu-Nan (TW)

(21) Appl. No.: 14/718,936

(22) Filed: May 21, 2015

(30) Foreign Application Priority Data
Feb. 16, 2015 (TW) 104105314

(51) Int. Cl. G06F 3/041

(52) U.S. Cl. CPC G06F 3/0412

(57) ABSTRACT

A touch panel including a first substrate and a touch electrode layer is provided. The first substrate has a touch area and a trace area outside the touch area. The touch electrode layer is disposed on the first substrate and includes a plurality of touch electrodes and a first trace. The touch electrodes are disposed on the touch area. The first trace has a trace portion disposed on the trace area, a contact portion disposed on the touch area, and a connecting portion. The contact portion is electrically connected to at least one of the touch electrodes. The connecting portion has a first end and a second end. The first end is connected to the trace portion and the second end is connected to the contact portion. A first width of the first end is smaller than a second width of the second end.

This application claims the benefit of Taiwan application Serial No. 104105314, filed Feb. 16, 2015, the disclosure of which is incorporated by reference herein in its entirety.

### TECHNICAL FIELD

The disclosure relates in general to a touch panel and a touch display device using the same.

### BACKGROUND

With the development of technology, touch display devices have been widely used in mobile phones, tablet PCs, notebook computers and other electronic devices. In order to facilitate devices carrying, such electronic devices are manufactured thinner and lighter. However, the inner traces have been more complicated with the more functions of the electronic devices, such that signals may disturb each other or the electrostatic discharge (ESD) may be occurred. Therefore, effectively solving the problems mentioned above in the limited spaces has been a main goal in the technical field.

### SUMMARY

The disclosure is directed to a touch panel and a touch display device using the same. The signals disturbing between the adjacent traces or the electrostatic discharge resulting from the electrostatic accumulation in the end points of the traces may be effectively solved by the design of the inner traces.

According to one embodiment, a touch panel including a first substrate and a touch electrode layer is provided. The first substrate has a touch area and a trace area outside the touch area. The touch electrode layer is disposed on the first substrate and includes a plurality of touch electrodes and a first trace. The touch electrodes are disposed on the touch area. The first trace has a trace portion disposed on the trace area, a contact portion disposed on the touch area, and a connecting portion. The contact portion is electrically connected to at least one of the touch electrodes. The connecting portion has a first end and a second end. The first end is connected to the trace portion and the second end is connected to the contact portion. A first width of the first end is smaller than a second width of the second end.

According to another embodiment, a touch display device including a first substrate, an array layer disposed on the first substrate, a display medium layer disposed on the array layer, a second substrate disposed on the display medium layer, a protection layer disposed on the second substrate, and a touch electrode layer disposed between the protection layer and the first substrate is provided. The touch electrode layer includes a plurality of touch electrodes disposed on a touch area, and a first trace. The first trace has a trace portion disposed on a trace area outside the touch area, a contact portion disposed on the touch area and electrically connected to at least one of the touch electrodes, and a connecting portion having a first end connected to the trace portion and a second end connected to the contact portion. A first width of the first end is smaller than a second width of the second end.

### BRIEF DESCRIPTION OF THE DRAWINGS

FIG. 1 illustrates a top view of the touch panel in one embodiment according to the disclosure.

FIG. 2A illustrates an enlarged schematic diagram of area A in FIG. 1.

FIG. 2B illustrates a top view of the touch panel in another embodiment according to the disclosure.

FIG. 2C illustrates a top view of the touch panel in still another embodiment according to the disclosure.

FIG. 3A to FIG. 3D respectively illustrate the cross-section view of the touch display devices in the embodiments according to the disclosure.

FIG. 4A to FIG. 4C respectively illustrate the cross-section view of the touch display devices in the embodiments according to the disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The embodiments are described in details with reference to the accompanying drawings. The identical elements of the embodiments are designated with the same reference numerals. Also, it is important to point out that the illustrations may not be necessarily drawn to scale, and that there may be other embodiments of the present disclosure which are not specifically illustrated. Thus, the specification and the drawings are regarded as an illustrative sense rather than a restrictive sense.

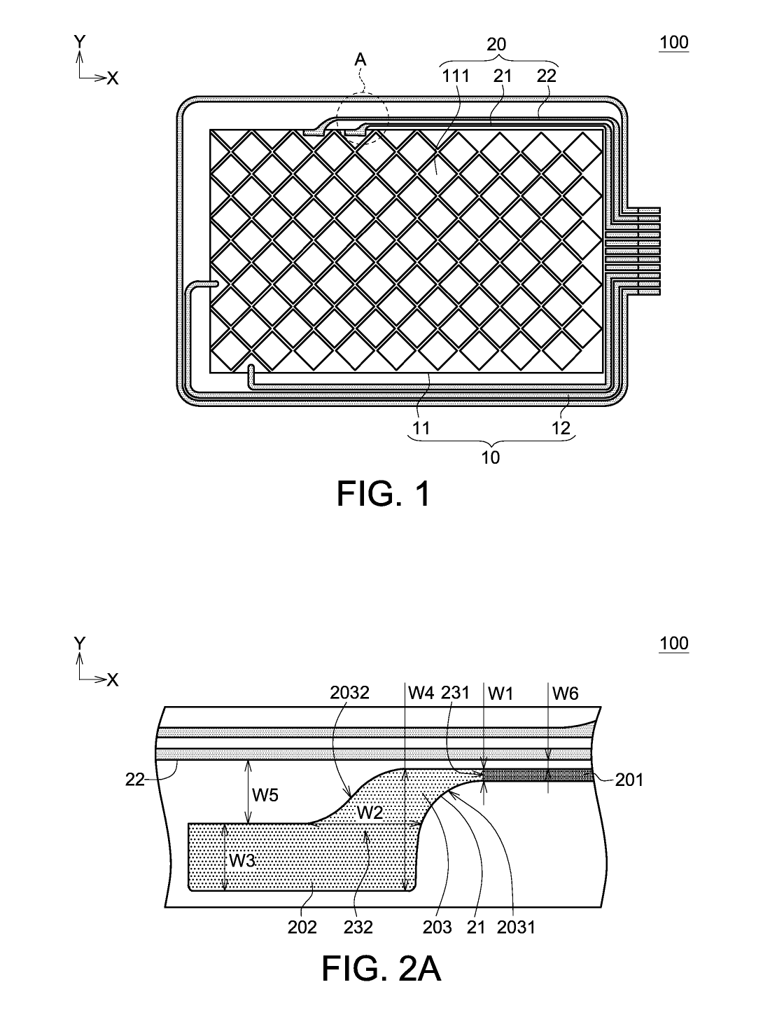

FIG. 1 illustrates a top view of the touch panel 100 in one embodiment according to the disclosure. As shown in FIG. 1, the touch panel 100 includes a first substrate 10 and a touch electrode layer 20. The first substrate 10 has a touch area 11 and a trace area 12 outside the touch area 11. In this embodiment, the trace area 12 is disposed on the periphery of the touch area 11. The touch electrode layer 20 is disposed on the first substrate 10 and includes a plurality of touch electrodes 111 and a first trace 21. The touch electrodes 111 are in the touch area 11.

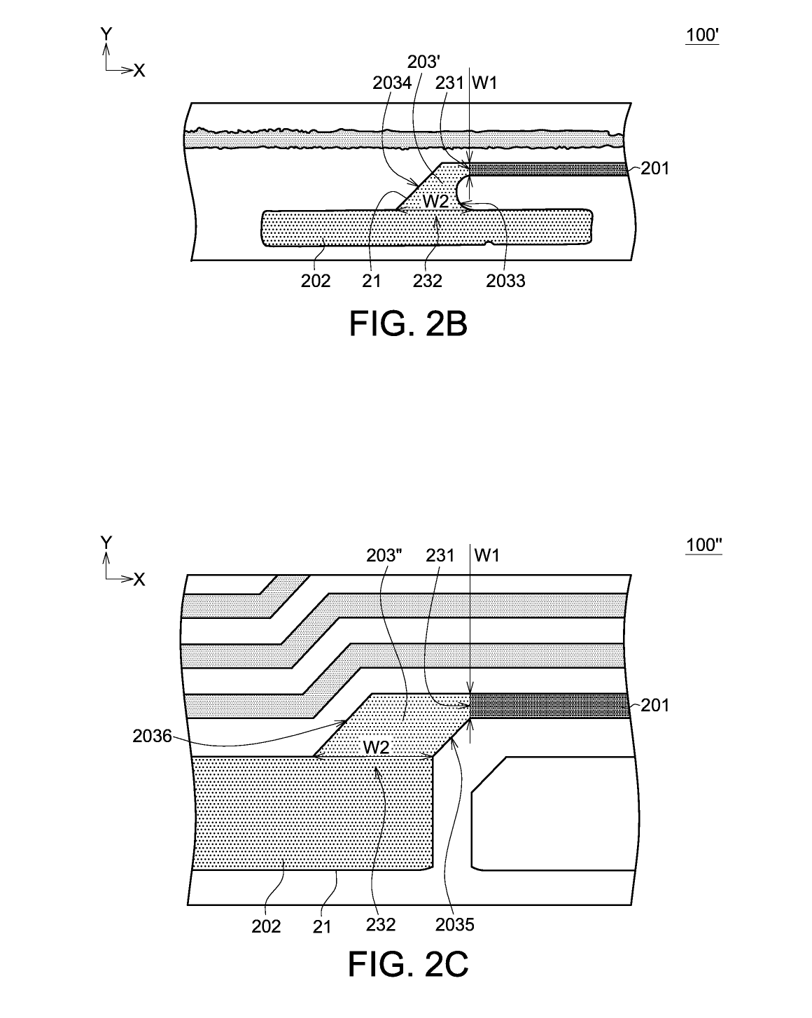

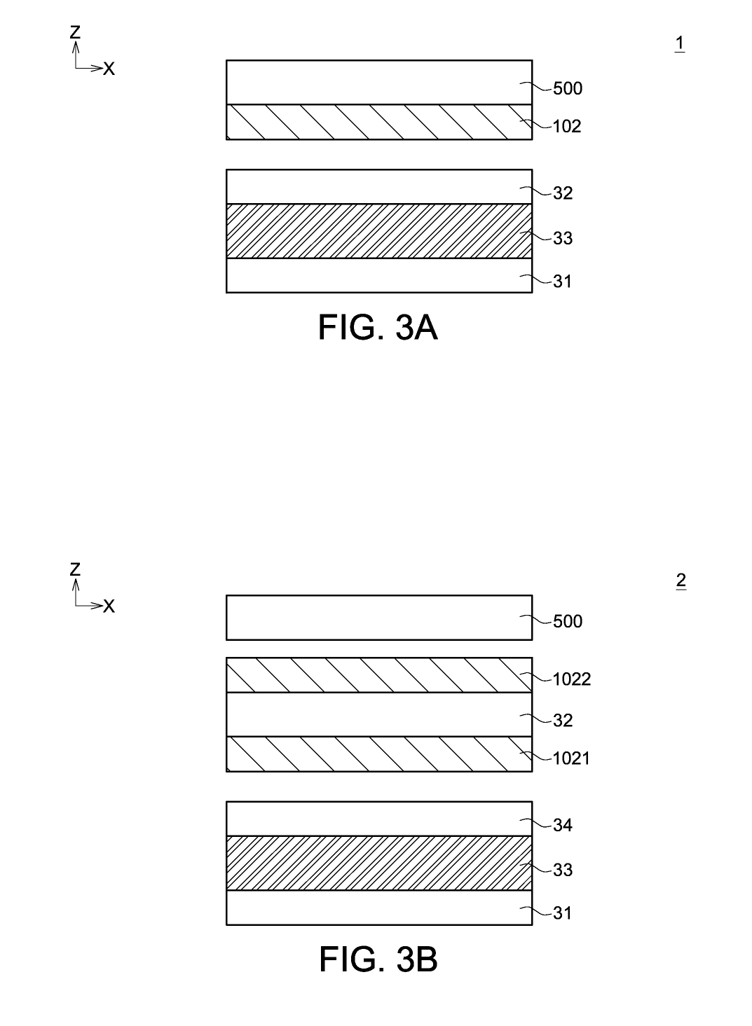

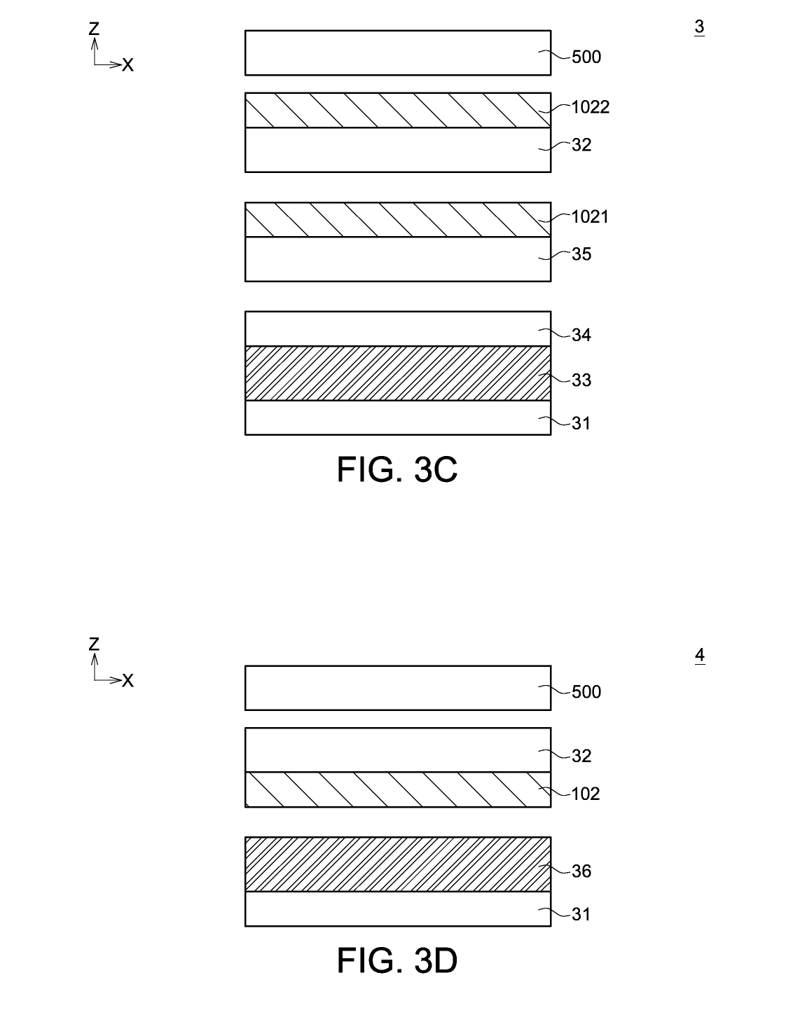

FIG. 2A illustrates an enlarged schematic diagram of area A in FIG. 1. As shown in FIG. 1 and FIG. 2A, the first trace 21 of the touch panel 100 has a trace portion 201, a contact portion 202 and a connecting portion 203. The trace portion 201 is disposed on the trace area 12. The contact portion 202 is disposed on the touch area 11 and electrically connected to at least one of the touch electrodes 111. The connecting portion 203 has a first end 231 and a second end 232. The first end 231 is connected to the trace portion 201, and the second end 232 is connected to the contact portion 202.

In this embodiment, the first end 231 of the connecting portion 203 has a first width W1 and the second end 232 of the connecting portion 203 has a second width W2 different from the first width W1. For example, the trace portion 201 is extended along a first direction (X-direction) in FIG. 2A. The first width W1 is such as a width of the first end 231 of the connecting portion 203 perpendicular to the first direction (along Y-direction), the second width W2 is such as a width of the second end 232 of the connecting portion 203 along the first direction (X-direction), and the first width W1 is smaller than the second width W2. In more detail, a projection of the second end 232 on the first substrate 10 may overlap a portion of the edge of the touch electrodes 111 connected to the first trace 21.

Besides, the connecting portion 203 in the embodiment according to the disclosure has a first side 2031 and a second side 2032. The first side 2031 is a curve having a first curvature, and the second side 2032 may also be a curve having a second curvature different from the first curvature. Here, the first curvature is defined as an average curvature of the points on the first side 2031, and the second curvature is defined as an average curvature of the points on the second side 2032. For example, the first curvature may larger than the second curvature in the embodiment of the disclosure, such that the widths of the connecting portion 203 from the first end 231 to the second end 232 may be increasing.

As shown in FIG. 2A, a width of the trace portion 201 of the first trace 21 perpendicular to the first direction (along Y-direction) is substantially the same as the first width W1. A maximum width of the contact portion 202 perpendicular to the first direction (along Y-direction) is a third width W3. A maximum width of the first trace 21 perpendicular to the first direction (along Y-direction) is a fourth width W4. The first width W1 is smaller than the third width W3, and the third width W3 is smaller than the fourth width W4.

In this embodiment, the touch electrode layer 20 of the touch panel 100 further includes a second trace 22 disposed on the first substrate 10 and adjacent to the first trace 21. Besides, the structure of the second trace 22 is similar to the structure of the first trace 21, which would not be narrated herein. As shown in FIG. 2A, a minimum distance W5 between the contact portion 202 of the first trace 21 and the second trace 22 is larger than a minimum distance W6 between the trace portion 201 of the first trace 21 and the second trace 22.

Since two ends (first end 231 and second end 232) of the connecting portion 203 have different first width W1 and second width W2, and the first width W1 is smaller than the second width W2, when the signal is transferred from the trace portion 201 to the contact portion 202 via the connecting portion 203 of the first trace 21, the junction resistance would be smaller.

Further, since the first side 2031 and the second side 2032 of the connecting portion 203 are curves, it may be effectively prevented from the electrostatic discharge (ESD) resulting from the electrostatic accumulation.

Furthermore, since the minimum distance W5 between the contact portion 202 of the first trace 21 and the second trace 22 is larger than the minimum distance W6 between the trace portion 201 of the first trace 21 and the second trace 22, it may be effectively prevented the contact portion 202 of the first trace 21 from being disturbed by the adjacent trace (second trace 22).

FIG. 2B illustrates a top view of the touch panel 100′ in another embodiment according to the disclosure. Similar to the structure shown in FIG. 2A, the touch electrode layer of the touch panel 100′ includes a first trace 21, and the first trace 21 has a trace portion 201, a contact portion 202, and a connecting portion 203′. The connecting portion 203′ has a first end 231 and a second end 232. The first end 231 is connected to the trace portion 201, and the second end 232 is connected to the contact portion 202.

In the embodiment shown in FIG. 2B, the first end 231 of the connecting portion 203′ has a first width W1, the second end 232 of the connecting portion 203′ has a second width W2, and the first width W1 is smaller than the second width W2.

The connecting portion 203′ in the embodiment according to the disclosure has a first side 2033 and a second side 2034. It is different from the embodiment shown in FIG. 2A that the first side 2033 is a curve having a first curvature, while the second side 2034 is a polygonal line. Similarly, the first curvature is defined as an average curvature of the points on the first side 2033. The description of other elements similar to the touch panel 100 shown in FIG. 2A would be omitted herein. It should be noted that the second side 2034 may be a straight line in another embodiment.

FIG. 2C illustrates a top view of the touch panel 100″ in still another embodiment according to the disclosure. Similar to the structure shown in FIG. 2A, the touch electrode of the touch panel 100″ includes a first trace 21, and the first trace 21 has a trace portion 201, a contact portion 202, and a connecting portion 203″. The connecting portion 203″ has a first end 231 and a second end 232. The first end 231 is connected to the trace portion 201, and the second end 232 is connected to the contact portion 202.

In the embodiment shown in FIG. 2C, the first end 231 of the connecting portion 203″ has a first width W1, the second end 232 of the connecting portion 203″ has a second width W2, and the first width W1 is smaller than the second width W2.

The connecting portion 203″ in the embodiment according to the disclosure has a first side 2035 and a second side 2036. It is different from the embodiment shown in FIG. 2A that the first side 2035 is a straight line, and the second side 2036 may be a polygonal line.

In the embodiments shown in FIG. 2A to FIG. 2C, the contact portions 202 are illustrated as rectangles, but the disclosure is not limited thereto. The shape of the contact portion 202 may be determined by the configuration of the touch panel. Besides, when the contact portion 202 is rectangular, the four corner of the contact portion 202 may be round corners to prevent from the electrostatic discharge (ESD).

Besides, the traces disposed on the touch electrode layer 20 (such as the first trace 21 and the second trace 22) may be formed by inkjet printing, screen printing or photolithography.

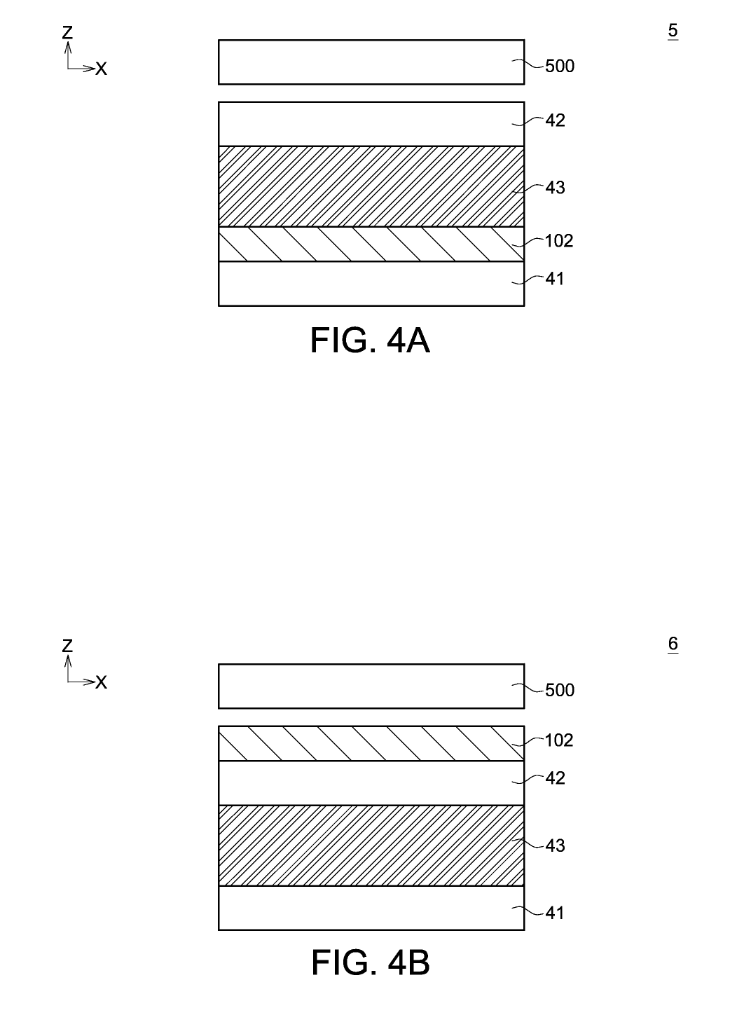

The touch panels in the embodiments above may be applied to various touch display devices. FIG. 3A to FIG. 3D respectively illustrate the cross-section view of the touch display devices 1 to 4 in the embodiments according to the disclosure.

As shown in FIG. 3A, the touch display device 1 may be such as an out-cell touch display device, and include a first substrate 31, an array layer (not shown), a display medium layer 33, a second substrate 32, a protection layer 500 and a touch electrode layer 102. The array layer is disposed on the first substrate 31. The display medium layer 33 is disposed on the array layer. The second substrate 32 is disposed on the display medium layer 33. The protection layer 500 is disposed on the second substrate 32. The touch electrode layer 102 is disposed between the protection layer 500 and the first substrate 31. In this embodiment, the touch electrode layer 102 is disposed between the protection layer 500 and the second substrate 32.

The touch electrode layer 102 may have the structure similar to the touch electrode layer 20 as shown in FIG. 1 and FIG. 2A, and include a plurality of touch electrodes 111 and a first trace 21. The touch electrodes 111 are disposed on the touch area 11. The first trace 21 has a trace portion 201, a contact portion 202 and a connecting portion 203. The trace portion 201 is disposed on the trace area 12 outside the touch area 11. The contact portion 202 is disposed on the touch area 11 and electrically connected to at least one of the touch electrodes 111. The connecting portion 203 has a first end 231 and a second end 232. The first end 231 is connected to the trace portion 201, and the second end 232 is connected to the contact portion 202. The first end 231 of the connecting portion 203 has a first width W1, and the second end 232 of the connecting portion 203 has a second width W2 different from the first width W1. In one embodiment, the first width W1 may be smaller than the second width W2. The touch electrode layer 102 in the embodiment according to the disclosure may include electrodes Tx and Rx arranged along different directions. Therefore, the touch electrode layer 102 may be stacked electrodes Tx, Rx or coplanar electrodes Tx, Rx.

In this embodiment, the protection layer 500 may be such as a cover glass, the first substrate 31 may be such as an array substrate, the second substrate 32 may be such as a color filter substrate, and the display medium layer 33 may be such as a liquid crystal layer. However, the disclosure is not limited thereto.

As shown in FIG. 3B, the touch display device 2 may be such as an out-cell touch display device, and include a first substrate 31, an array layer (not shown), a display medium layer 33, a second substrate 32, a protection layer 500, a first touch electrode layer 1021, and a second touch electrode layer 1022. The array layer is disposed on the first substrate 31. The display medium layer 33 is disposed on the array layer. The second substrate 32 is disposed on the display medium layer 33. The protection layer 500 is disposed on the second substrate 32. In this embodiment, the first touch electrode layer 1021 is disposed between the second substrate 32 and the display medium layer 33, the second touch electrode layer 1022 is disposed between the second substrate 32 and the protection layer 500, and the second substrate 32 may be a thin film.

The first touch electrode layer 1021 and the second touch electrode layer 1022 may have the structure similar to the touch electrode layer 20 as shown in FIG. 1 and FIG. 2A, and include a plurality of touch electrodes 111 and a first trace 21. The touch electrodes 111 are disposed on the touch area 11. The first trace 21 has a trace portion 201, a contact portion 202 and a connecting portion 203. The trace portion 201 is disposed on the trace area 12 outside the touch area 11. The contact portion 202 is disposed on the touch area 11 and electrically connected to at least one of the touch electrodes 111. The connecting portion 203 has a first end 231 and a second end 232. The first end 231 is connected to the trace portion 201, and the second end 232 is connected to the contact portion 202. The first end 231 of the connecting portion 203 has a first width W1, and the second end 232 of the connecting portion 203 has a second width W2 different from the first width W1. In one embodiment, the first width W1 may be smaller than the second width W2. The first touch electrode layer 1021 and the second touch layer 1022 in the embodiment according to the disclosure may include electrodes Tx and Rx arranged along different directions.

In this embodiment, the touch display device 2 may further include a color filter substrate 34 disposed between the display medium layer 33 and the first touch electrode 1021.

As shown in FIG. 3C, the touch display device 3 may be such as an out-cell touch display device, and include a first substrate 31, an array layer (not shown), a display medium layer 33, a second substrate 32, a protection layer 500, a first touch electrode layer 1021, and a second touch electrode layer 1022. The array layer is disposed on the first substrate 31. The display medium layer 33 is disposed on the array layer. The second substrate 32 is disposed on the display medium layer 33. The protection layer 500 is disposed on the second substrate 32. The first touch electrode layer 1021 is disposed between the second substrate 32 and the display medium layer 33, the second touch electrode layer 1022 is disposed between the second substrate 32 and the protection layer 500, and the second substrate 32 may be a thin film.

In this embodiment, the touch display device 3 may further include a third substrate 35 disposed between the first touch electrode layer 1021 and the display medium layer 33, and the third substrate 35 may be a thin film similar to the second substrate 32. Besides, the first touch electrode layer 1021 and the second touch electrode layer 1022 may respectively include electrodes Tx and Rx arranged along different directions.

The first touch electrode layer 1021 and the second touch electrode layer 1022 may have the structure similar to the touch electrode layer 20 as shown in FIG. 1 and FIG. 2A, and include a plurality of touch electrodes 111 and a first trace 21. The touch electrodes 111 are disposed on the touch area 11. The first trace 21 has a trace portion 201, a contact portion 202 and a connecting portion 203. The trace portion 201 is disposed on the trace area 12 outside the touch area 11. The contact portion 202 is disposed on the touch area 11 and electrically connected to at least one of the touch electrodes 111. The connecting portion 203 has a first end 231 and a second end 232. The first end 231 is connected to the trace portion 201, and the second end 232 is connected to the contact portion 202. The first end 231 of the connecting portion 203 has a first width W1, and the second end 232 of the connecting portion 203 has a second width W2 different from the first width W1. In one embodiment, the first width W1 may be smaller than the second width W2.

Further, the touch display device 3 may include a color filter substrate 34 disposed between the display medium layer 33 and the third substrate 35.

As shown in FIG. 3D, the touch display device 4 may be such as an on-cell touch display device, and include a first substrate 31, an array layer (not shown), a display medium layer 36, a second substrate 32, a protection layer 500 and a touch electrode layer 102. The array layer is disposed on the first substrate 31. The display medium layer 36 is disposed on the array layer. The second substrate 32 is disposed on the display medium layer 36. The protection layer 500 is disposed on the second substrate 32. The touch electrode layer 102 is disposed between the protection layer 500 and the first substrate 31. In this embodiment, the touch electrode layer 102 is disposed between the second substrate 32 and the display medium layer 36.

The touch electrode layer 102 may have the structure similar to the touch electrode layer 20 as shown in FIG. 1 and FIG. 2A, and include a plurality of touch electrodes 111 and a first trace 21. The touch electrodes 111 are disposed on the touch area 11. The first trace 21 has a trace portion 201, a contact portion 202 and a connecting portion 203. The trace portion 201 is disposed on the trace area 12 outside the touch area 11. The contact portion 202 is disposed on the touch area 11 and electrically connected to at least one of the touch electrodes 111. The connecting portion 203 has a first end 231 and a second end 232. The first end 231 is connected to the trace portion 201, and the second end 232 is connected to the contact portion 202. The first end 231 of the connecting portion 203 has a first width W1, and the second end 232 of the connecting portion 203 has a second width W2 different from the first width W1. In one embodiment, the first width W1 may be smaller than the second width W2.

In this embodiment, the display medium layer 36 may be such as an organic light-emitting diode (OLED) layer, and the touch electrode layer 102 in the embodiment according to the disclosure may include electrodes Tx and Rx arranged along different directions. Therefore, the touch electrode layer 102 may be stacked electrodes Tx, Rx or coplanar electrodes Tx, Rx.

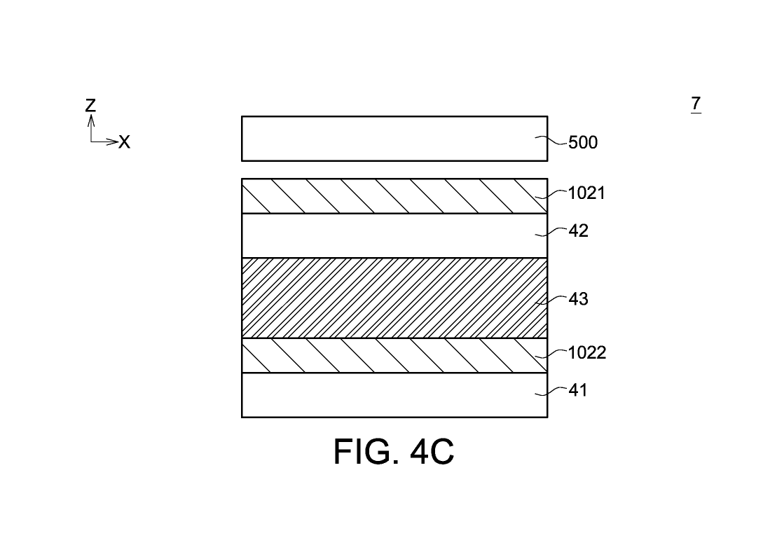

FIG. 4A to FIG. 4C respectively illustrate the cross-section view of the touch display devices 5 to 7 in the embodiments according to the disclosure. As shown in FIG. 4A, the touch display device 5 may be such as an in-cell touch display device, and include a first substrate 41, an array layer (not shown), a display medium layer 43, a second substrate 42, a protection layer 500 and a touch electrode layer 102. The array layer is disposed on the first substrate 41. The display medium layer 43 is disposed on the array layer. The second substrate 42 is disposed on the display medium layer 43. The protection layer 500 is disposed on the second substrate 42. The touch electrode layer 102 is disposed between display medium layer 43 and the first substrate 41.

The touch electrode layer 102 may have the structure similar to the touch electrode layer 20 as shown in FIG. 1 and FIG. 2A, and include a plurality of touch electrodes 111 and a first trace 21. The touch electrodes 111 are disposed on the touch area 11. The first trace 21 has a trace portion 201, a contact portion 202 and a connecting portion 203. The trace portion 201 is disposed on the trace area 12 outside the touch area 11. The contact portion 202 is disposed on the touch area 11 and electrically connected to at least one of the touch electrodes 111. The connecting portion 203 has a first end 231 and a second end 232. The first end 231 is connected to the trace portion 201, and the second end 232 is connected to the contact portion 202. The first end 231 of the connecting portion 203 has a first width W1, and the second end 232 of the connecting portion 203 has a second width W2 different from the first width W1. In one embodiment, the first width W1 may be smaller than the second width W2.

In this embodiment, the protection layer 500 may be such as a cover glass, the first substrate 41 may be such as an array substrate, and the display medium layer 43 may be such as a liquid crystal layer. The touch electrode layer 102 in the embodiment according to the disclosure may include electrodes Tx and Rx arranged along different directions. Therefore, the touch electrode layer 102 may be stacked electrodes Tx, Rx or coplanar electrodes Tx, Rx.

As shown in FIG. 4B, the touch display device 6 may be such as an on-cell touch display device, and include a first substrate 41, an array layer (not shown), a display medium layer 43, a second substrate 42, a protection layer 500 and a touch electrode layer 102. The array layer is disposed on the first substrate 41. The display medium layer 43 is disposed on the array layer. The second substrate 42 is disposed on the display medium layer 43. The protection layer 500 is disposed on the second substrate 42. The touch electrode layer 102 is disposed between protection layer 500 and the first substrate 41. In this embodiment, the touch electrode layer 102 is disposed between protection layer 500 and the second substrate 42.

The touch electrode layer 102 may have the structure similar to the touch electrode layer 20 as shown in FIG. 1 and FIG. 2A, and include a plurality of touch electrodes 111 and a first trace 21. The touch electrodes 111 are disposed on the touch area 11. The first trace 21 has a trace portion 201, a contact portion 202 and a connecting portion 203. The trace portion 201 is disposed on the trace area 12 outside the touch area 11. The contact portion 202 is disposed on the touch area 11 and electrically connected to at least one of the touch electrodes 111. The connecting portion 203 has a first end 231 and a second end 232. The first end 231 is connected to the trace portion 201, and the second end 232 is connected to the contact portion 202. The first end 231 of the connecting portion 203 has a first width W1, and the second end 232 of the connecting portion 203 has a second width W2 different from the first width W1. In one embodiment, the first width W1 may be smaller than the second width W2.

In this embodiment, the second substrate 42 may be such as a color filter substrate, and the display medium layer 43 may be such as a liquid crystal layer.

As shown in FIG. 4C, the touch display device 7 may be such as an hybrid in-cell touch display device, and include a first substrate 41, an array layer (not shown), a display medium layer 43, a second substrate 42, a protection layer 500, a first touch electrode layer 1021, and a second touch electrode layer 1022. The array layer is disposed on the first substrate 41. The display medium layer 43 is disposed on the array layer. The second substrate 42 is disposed on the display medium layer 43. The protection layer 500 is disposed on the second substrate 42. In this embodiment, the first touch electrode layer 1021 is disposed between the protection layer 500 and the second substrate 42, and the second touch electrode layer 1022 is disposed between the display medium layer 43 and the first substrate 41.

The first touch electrode layer 1021 and the second touch electrode layer 1022 may have the structure similar to the touch electrode layer 20 as shown in FIG. 1 and FIG. 2A, and include a plurality of touch electrodes 111 and a first trace 21. The touch electrodes 111 are disposed on the touch area 11. The first trace 21 has a trace portion 201, a contact portion 202 and a connecting portion 203. The trace portion 201 is disposed on the trace area 12 outside the touch area 11. The contact portion 202 is disposed on the touch area 11 and electrically connected to at least one of the touch electrodes 111. The connecting portion 203 has a first end 231 and a second end 232. The first end 231 is connected to the trace portion 201, and the second end 232 is connected to the contact portion 202. The first end 231 of the connecting portion 203 has a first width W1, and the second end 232 of the connecting portion 203 has a second width W2 different from the first width W1. In one embodiment, the first width W1 may be smaller than the second width W2. The first touch electrode layer 1021 and the second touch electrode layer 1022 in the embodiment according to the disclosure may include electrodes Tx and Rx arranged along different directions.

In this embodiment, the first substrate 41 of the touch display device 7 may be such as an array substrate, and the second substrate 42 of the touch display device 7 may be such as a color filter substrate.

Although the touch display devices 1 to 7 in the examples above includes the touch panel 100 as shown in FIG. 1 and FIG. 2A, the disclosure is not limited thereto. Instead, the touch panel 100′ in FIG. 2B or the touch panel 100″ in FIG. 2C may also be applied to the touch display devices 1 to 7.

Besides, the touch display devices 1 to 7 may respectively include a color filter layer (not shown in the Figures). The color filter layer may be disposed between the display medium (33, 34) and the second substrate (32, 42), or between the array layer and the display medium layer (33, 43).

As described in the embodiments above, since the connecting portion according to the disclosure has different widths, when the signal is transferred from the trace portion to the contact portion via the connecting portion, the junction resistance would be smaller. Further, the first side and the second side of the connecting portion may be curves, so that it may be effectively prevented from the electrostatic discharge (ESD) resulting from the electrostatic accumulation.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A touch panel, comprising:
a first substrate having a touch area and a trace area outside the touch area; and
a touch electrode layer disposed on the first substrate and comprising:
a plurality of touch electrodes disposed on the touch area; and
a first trace including:
a trace portion disposed on the trace area;
a contact portion disposed on the touch area and electrically connected to at least one of the touch electrodes; and
a connecting portion having a first end connected to the trace portion and a second end connected to the contact portion;
wherein a first width of the first end is smaller than a second width of the second end.

2. The touch panel according to claim 1, wherein the connecting portion has a first side, and the first side is a curve having a first curvature.

3. The touch panel according to claim 2, wherein the connecting portion has a second side, and the second side is a curve having a second curvature different from the first curvature.

4. The touch panel according to claim 1, wherein the connecting portion has a first side, and the first side is a straight line or a polygonal line.

5. The touch panel according to claim 1, wherein the trace portion is extended along a first direction, a width of the first end perpendicular to the first direction is the first width, a maximum width of the contact portion perpendicular to the first direction is a third width, a maximum width of the first trace perpendicular to the first direction is a fourth width, the first width is smaller than the third width, and the third width is smaller than the fourth width.

6. The touch panel according to claim 1, wherein the touch electrode layer further comprises:
a second trace disposed adjacent to the first trace,
wherein a minimum distance between the contact portion and the second trace is larger than a minimum distance between the trace portion and the second trace.

7. A touch display device, comprising:
a first substrate;
an array layer disposed on the first substrate;
a display medium layer disposed on the array layer;
a second substrate disposed on the display medium layer;
a protection layer disposed on the second substrate; and
a touch electrode layer disposed between the protection layer and the first substrate, and comprising:
a plurality of touch electrodes disposed on a touch area; and
a first trace including:
a trace portion disposed on a trace area outside the touch area;
a contact portion disposed on the touch area and electrically connected to at least one of the touch electrodes; and
a connecting portion having a first end connected to the trace portion and a second end connected to the contact portion;
wherein a first width of the first end is smaller than a second width of the second end.

8. The touch display device according to claim 7, wherein the touch electrode layer is disposed between the protection layer and the second substrate, between the second substrate and the display medium layer, or between the display medium layer and the first substrate.

9. The touch display device according to claim 7, wherein the touch electrode layer comprises a first touch electrode layer disposed between the second substrate and the display medium layer and a second touch electrode layer disposed between the second substrate and the protection layer, and the second substrate is a thin film.

10. The touch display device according to claim 9, further comprising:
a third substrate disposed between the first touch electrode layer and the display medium layer,
wherein the third substrate is a thin film.

11. The touch display device according to claim 7, further comprising:
a color filter layer disposed between the display medium layer and the second substrate, or between the array layer and the display medium layer.

12. The touch display device according to claim 7, wherein the connecting portion has a first side, and the first side is a curve having a first curvature.

13. The touch display device according to claim 12, wherein the connecting portion has a second side, and the second side is a curve having a second curvature different from the first curvature.

14. The touch display device according to claim 7, wherein the connecting portion has a first side, and the first side is a straight line or a polygonal line.

15. The touch display device according to claim 7, wherein the trace portion is extended along a first direction, a width of the first end perpendicular to the first direction is the first width, a maximum width of the contact portion perpendicular to the first direction is a third width, a maximum width of the first trace perpendicular to the first direction is a fourth width, the first width is smaller than the third width, and the third width is smaller than the fourth width.

16. The touch display device according to claim 7, wherein the touch electrode layer further comprises:
a second trace disposed adjacent to the first trace,
wherein a minimum distance between the contact portion and the second trace is larger than a minimum distance between the trace portion and the second trace.
